(19) United States
(12) Patent Application Publication
(10) Pub. No.: US 2015/0223483 A1
(43) Pub. Date: Aug. 13, 2015

(54) OMEGA-9 CANOLA OIL BLENDED WITH DHA

(71) Applicants: DOW AGROSCIENCES LLC, Indianapolis, IN (US); DSM IP ASSETS B.V., Te Heerlen (NL)

(72) Inventors: Asim Syed, Carmel, IN (US); David Dzisiak, Calgary (CA); Robert Gillison, Baltimore, MD (US); Chiaping Charles Hsu, Ellicott City, MD (US); Wei Wang-Nolan, Sharon, MA (US); S.P. Janaka Namal Senanayake, Olathe, KS (US)

(21) Appl. No.: 14/427,278

(22) PCT Filed: Sep. 10, 2013
(86) PCT No.: PCT/US2013/058860

§ 371 Date: Mar. 10, 2015

Related U.S. Application Data
(60) Provisional application No. 61/699,679, filed on Sep. 11, 2012.

(51) Int. Cl. A23D 9/00; A23D 9/007

(52) U.S. Cl. CPC A23D 9/00; A23D 9/007

(57) ABSTRACT

An oil composition containing omega-9 canola oil is disclosed in which the canola oil is stabilized against oxidation. The omega-9 canola oil contains more than 68% oleic acid and less than 4% linolenic acid. In particular embodiments, the oil composition contains 0.1-1.0 weight percent omega-3 fatty acids, which may be DHA, and may contain additional anti-oxidants, such as tocopherols. Oxidatively resistant oil compositions and food compositions containing omega-9 canola oil with DHA are also disclosed. Methods for increasing the oxidative stability of omega-9 canola oil by addition of DHA are also disclosed.

### PRIORITY CLAIM

This application claims the benefit of the filing date of U.S. Provisional Patent Application Ser. No. 61/699,679, filed Sep. 11, 2012, for “Omega-9 Canola Oil Blended With DHA.”

### JOINT RESEARCH AGREEMENT

The presently claimed invention was made by or on behalf of the below listed parties to a joint research agreement. The joint research agreement was in effect on or before the date the claimed invention was made and the claimed invention was made as a result of activities undertaken within the scope of the joint research agreement. The parties to the joint research agreement are Dow AgroSciences, LLC and MARTEK.

### TECHNICAL FIELD

The disclosure generally relates to an improved canola oil, methods for production of an improved canola oil, and food compositions with the improved canola oil. A composition of an omega-9 canola oil and an omega-3 fatty acid exhibits increased oxidative stability, as compared to commodity canola oil. The composition may also comprise antioxidants, such as tocopherols.

### BACKGROUND

Canola is a genetic variation of rapeseed developed by Canadian plant breeders specifically for its oil and meal attributes, particularly its low level of saturated fat. “Canola” generally refers to plants of Brassica species that have less than 2% erucic acid (Δ13-22:1) by weight in seed oil and less than 30 micromoles of glucosinolates per gram of oil free meal. Typically, canola oil contains saturated fatty acids, including palmitic acid and stearic acid; a monounsaturated fatty acid known as oleic acid; and polyunsaturated fatty acids, including linoleic acid and linolenic acid. These fatty acids may be described by the length of their carbon chain, and the number of double bonds in the chain. For example, oleic acid may be called C18:1, because it has an 18-carbon chain and one double bond; linoleic acid may be called C18:2, because it has an 18-carbon chain and two double bonds; and linolenic acid may be called C18:3, because it has an 18-carbon chain and three double bonds. The position of the first double bond (from the alkyl end of the fatty acid) may also be indicated, as with the omega-3 fatty acids, alpha-linolenic acid (18:3w-3) (ALA), eicosopentaneoic acid (EPA) (20:5w-3), and docosahexaenoic acid (DHA) (22:6w-3), wherein the first double bond is located at carbon 3.

Canola oil may contain less than about 7% total saturated fatty acids, and greater than 60% oleic acid (as percentages of total fatty acids). “Omega-9 canola oil” for example, contains a non-hydrogenated oil with a fatty acid content comprising at least 68.0% oleic acid by weight, and less than or equal to 4.0% linolenic acid by weight.

The fatty acid composition of a vegetable oil affects the oil's quality, stability, and health attributes. For example, oleic acid has been recognized to have certain health benefits, including effectiveness in lowering plasma cholesterol levels, making higher levels of oleic acid content in seed oil (>70%) a desirable trait. Under identical processing, formulation, packaging and storage conditions, the major difference in stability between different vegetable oils is due to their different fatty acid profiles. High oleic acid content vegetable oil is also preferred in cooking applications because of its increased resistance to oxidation in the presence of heat. Poor oxidative stability brings about shortened operation times in the case where the oil is used as a fry oil because oxidation produces off-flavors and odors that can greatly reduce the marketable value of the oil.

The foregoing examples of the related art and limitations related therewith are intended to be illustrative and not exclusive. Other limitations of the related art will become apparent to those of skill in the art upon a reading of the specification and study of the drawings.

### DISCLOSURE

The following embodiments and aspects thereof are meant to be exemplary and illustrative, not limiting in scope. In various embodiments, one or more of the above described problems is reduced or eliminated, while other embodiments are directed to other improvements.

In various aspects, a composition comprising an omega-9 canola oil and an omega-3 fatty acid is provided, having increased oxidative stability. In embodiments, the omega-3 fatty acid may be docosahexaenoic acid (DHA). In certain embodiments, DHA may be present in the composition at a concentration of 0.1 to 1.0 weight percent. In some embodiments, the composition may comprise an additional antioxidant. In certain embodiments, the antioxidant may comprise tocopherols or related antioxidants.

In another aspect, a method of increasing the oxidative stability of omega-9 canola oil by mixing DHA with the omega-9 canola oil, is disclosed. A method for preparing a canola oil composition with increased oxidative stability is also disclosed.

In further aspects, oxidation-resistant food compositions, and oil compositions, are disclosed, comprising omega-9 canola oil and DHA, where the omega-9 canola oil comprises at least 68% oleic acid and less than or equal to 4% linolenic acid by weight.

In addition to the exemplary aspects and embodiments described above, further aspects and embodiments will become apparent by reference to the drawings and by study of the following descriptions.

### BRIEF DESCRIPTION OF THE FIGURES

FIG. 1 is a histogram showing the fatty acid concentration profile of selected canola oil samples, as determined by FAME analysis.

FIG. 2 is a chart showing RANCIMAT™ values at 90° Celsius for selected canola oil samples.

FIG. 3 is a chart showing peroxide values (PV) (amount of peroxide oxygen per 1 kilogram of fat or oil) for selected canola oil samples.

FIG. 4 is a chart showing p-Anisidine (pAnV) values for selected canola oil samples.

FIG. 5 is a chart showing Totox values for selected canola oil samples.

FIG. 6 is a histogram showing initial fishy/painty (Initial F/P) aroma and aromatic intensities for selected canola oil samples, using a 15 point descriptive analysis scale.

FIG. 7 is a chart showing fishy/painty aroma of selected canola oil samples using a 15 point descriptive analysis scale for oil samples stored at room temperature.

FIG. 8 is a chart showing fishy/painty aromatics of selected canola oil samples using a 15 point descriptive analysis scale for oil samples stored at room temperature.

FIG. 9 is a chart showing fishy/painty aroma of selected canola oil samples using a 15 point descriptive analysis scale for oil samples stored at 32° Celsius.

FIG. 10 is a chart showing fishy/painty aromatics of selected canola oil samples using a 15 point descriptive analysis scale for oil samples stored at 32° Celsius.

FIG. 11 is a chart showing fishy/painty aroma of selected canola oil samples using a 15 point descriptive analysis scale for oil samples stored under ultraviolet light exposure.

FIG. 12 is a chart showing fishy/painty aromatics of selected canola oil samples using a 15 point descriptive analysis scale for oil samples stored under ultraviolet light exposure.

FIG. 13 is a chart showing the application of canola oil samples in the preparation of shredded potatoes, using a 6 point difference from control (DFC) scale.

FIG. 14 is a chart showing the application of canola oil samples in the preparation of vinaigrette dressing, using a 6 point difference from control (DFC) scale.

FIG. 15 is a chart showing the application of canola oil samples in the preparation of muffins, using a 6 point difference from control (DFC) scale.

### MODE(S) FOR CARRYING OUT THE INVENTION

In some aspects, an oil composition is provided that comprises an omega-9 canola oil and an omega-3 fatty acid, with comparable or superior oxidative stability to market leader canola oil. As used herein, the term “omega-9 oil” or “omega-9 canola oil” refers to a canola oil composition comprising at least 68.0% oleic acid by weight and less than or equal to 4.0% linolenic acid by weight. In some embodiments, the omega-9 canola oil may comprise at least 70% oleic acid by weight. In some embodiments, the omega-9 canola oil may comprise less than 3.0% linolenic acid by weight. Omega-9 canola oil is marketed as NATREON™ by Dow Agrosciences (Indianapolis, Ind.), and thus may be referred to herein as “Omega-9 canola oil,” “DowAgro canola oil,” or “DowAgro Omega-9 Canola Oil.” Omega-9 canola oil, and methods for generating omega-9 canola oil in Brassica juncea are disclosed in US2010/0143570 A1.

In various embodiments, an omega-3 fatty acid may comprise docosahexaenoic acid (DHA) (22:6 w-3), eicosopentaneoic acid (EPA) (20:5 w-3), or alpha-linolenic acid (18:3 w-3). DHA is a long-chain fatty acid that serves as the primary structural fatty acid in the brain and eyes, and supports brain, eye and cardiovascular health throughout life (See, e.g., Hashimoto and Hossain, 2011; Kiso, 2011). DHA is primarily obtained from fish oil or algal fermentation. Nutritionists recommend that people increase their consumption of DHA, because most people do not get enough in their diet. A fish-free, algal source of DHA suitable for use herein is marketed as LIFE'S DHA™ by Martek Biosciences (Columbia, Md.). In some embodiments, DHA may be added to omega-9 canola oil to achieve a final concentration of about 0.1% to about 1.0% (w/w) in an oil composition. In certain embodiments, DHA may be present in a final concentration of about 0.1%, 0.2%, 0.23%, 0.25%, 0.5%, or 1.0% (w/w) in the oil composition. Addition of DHA to omega-9 canola oil is expected to improve the health benefits of the canola oil composition.

Various chemical methods may be used to determine the fatty acid composition of oil compositions disclosed herein. For example, the fatty acid methyl esterase (FAME) method is widely used for this purpose. FAME analysis involves an alkali-catalyzed reaction between fats (e.g. oils) or fatty acids and methanol. The fatty acid methyl esters may then be analyzed using gas chromatography (GC) or other methods known to those of skill in the art.

As used herein, the “oxidative stability” or “oxidation-resistance” of a fatty acid or oil refers to its resistance to oxidation and associated chemical deterioration. Oxidation of an oil causes rancidity, unpleasant (fishy) odors, decreased nutritional value, and reduced marketability. Oil oxidation involves a complex series of reactions, first producing primary breakdown products (peroxides, dienes, free fatty acids), then secondary products (carbonyls, aldehydes, trienes), and finally tertiary products. The secondary products are frequently associated with the odor of rancid oil. Increased temperatures and prolonged storage increase the rate of oxidation. Not all fatty acids in vegetable oils are equally vulnerable to high temperature and oxidation, however. The susceptibility of individual fatty acids to oxidation is dependent on their degree of unsaturation. For example, linolenic acid (C18:3), with three carbon-carbon double bonds, oxidizes 98 times faster than oleic acid, with only one carbon-carbon double bond. Similarly, linoleic acid, with two carbon-carbon double bonds, oxidizes 41 times faster than oleic acid (R. T. Holman and O. C. Elmer, “The rates of oxidation of unsaturated fatty acid esters,” J. Am. Oil Chem. Soc. 24, 127-129 1947). For further information regarding the relative oxidation rates of oleic, linoleic and linolenic fatty acids, see Hawrysh, “Stability of Canola Oil,” Chap. 7, pp. 99-122, CANOLA AND RAPESEED: PRODUCTION, CHEMISTRY, NUTRITION, AND PROCESSING TECHNOLOGY, Shahidi, ed., Van Nostrand Reinhold, NY, 1990.

Marine oils are highly susceptible to oxidation, because of their large number of polyunsaturated fatty acids. Saturated fats, including typical animal fats and palm oils, are slower to oxidize, because they possess few, if any, carbon-carbon double bonds in their fatty acids. However, saturated fats are widely considered to be more unhealthy than fats and oils containing more mono- and polyunsaturated fatty acids.

Various methods may be used to measure the oxidative stability of an oil composition. These include, but are not limited to, the RANCIMAT™ method, which measures the oxidative stability index (OSI) of an oil sample. The principle of the RANCIMAT™ method is to heat an oil sample under constant aeration, trapping volatile components formed due to oxidation in water. The rate of formation of these volatile compounds is monitored by measuring an increase in electroconductivity, which gives an indication of the time to develop rancidity of an oil or oil blend. A higher OSI value is desirable, reflecting a longer time to oxidation.

Oxidation of oil compositions may also be measured using the peroxide value (PV) method, the anisidine value (AV) method (i.e., p-anisidine value method), and the Totox value method (Miller, 2012). These tests are frequently combined to yield a more complete oxidation profile. The PV method measures primary oxidation products, especially hydroperoxides. The PV method is sometimes described as a method of measuring “current” oxidation. Suitable PV methods known to those of skill in the art include the American Oil Chemists Society (AOCS) “Peroxide Value Acetic Acid-Chloroform Method” Cd8-53 (1997) method, and variants thereof. Similarly, the formation of aldehydic compounds in oils is a measurable indicator of rancidity. The AOCS Anisidine Value (AV) Method Cd18-90 (1997) is widely used to measure aldehyde content. In the presence of acetic acid, p-anisidine reacts with aldehydic compounds in oils and fats, creating a yellowish reaction product that may be quantified by measuring absorbance at 350 nm. The AV method is sometimes described as a method of measuring “past” oxidation of an oil. The Totox value method is obtained using the formula AV+2PV, which indicates an oil's overall oxidation state. Lower Totox values are desirable. Other methods of measuring oxidation and rancidity in oil compositions are known to those of skill in the art, including the acid value test (free fatty acid FFA), thiobarbituric acid value (TBA), and iodine value (IV).

Electronic odor detection systems (“artificial nose”), utilizing metal oxide sensors, may be used to discriminate between “normal” and irregular odors associated with rancidity. Controlled heating of oil samples may be used to facilitate comparison with known samples. An “aroma map” is generated in this way and used to evaluate the oxidative stability of various compositions. Humans trained to detect such odors are also widely used in the field of food research. Sensory tests may be used to rank the aroma and aromatic attributes (fishy/painty aroma) of various oil compositions on a 15 pt SPECTRUM™ scale, or other suitable scale. Taste studies may also be conducted to evaluate the flavor and desirability of various oil compositions, such as omega-9 canola oil, with and without DHA, in food preparations. Randomized, single- or double-blind methods known to those of skill in the art may be employed to minimize bias.

Storage conditions, durations, and temperatures may be modified to assess the influence of these factors on chemical and oxidative stability. For example, the presence of ultraviolet light, various metals (e.g., iron or copper), and moisture may increase the rate of oil oxidation. In some embodiments, an antioxidant may be added to the oil composition. Antioxidants may slow the rate of oxidation in oils by terminating oxidation chain reactions and interfering with formation of oxidation inteiniediates. Suitable antioxidants for use in an oil composition may include tocopherols (vitamin E), carotenoids, beta-carotene, retinol (vitamin A), citric acid, ascorbic acid (vitamin C), phosphoric acid, butylated hydroxytoluene (BHT), butylated hydroxyanisole (BHA), tert-butylhydroquinone (TBHQ), flavonoids, and tea catechins. Other suitable natural or synthetic antioxidants may be used. In certain embodiments, tocopherol may be added as an antioxidant to an oil composition. In some embodiments, DHA stock oil containing tocopherols at a concentration of about 600 ppm may be added to omega-9 canola oil to produce a suitable oil composition. Other antioxidant concentrations may be effective to confer an antioxidant benefit to the oil composition, and are encompassed herein.

Oils and oil compositions disclosed herein may also be used in various non-culinary applications. Some of these uses may be industrial, cosmetic, or medicinal uses where oxidative stability is desired. In general, the oil compositions may be used to replace, e.g., mineral oils, esters, fatty acids, or animal fats in a variety of applications, such as lubricants, lubricant additives, metal working fluids, hydraulic fluids and fire resistant hydraulic fluids. The oil compositions disclosed herein may also be used as materials in a process of producing modified oil compositions. Examples of techniques for modifying oil compositions include fractionation, hydrogenation, alteration of the oil's oleic acid or linolenic acid content, and other modification techniques known to those of skill in the art. In some embodiments, oil compositions may be used in the production of interesterified oils, the production of tristearins, or in a dielectric fluid composition. Such compositions may be included in an electrical apparatus. Examples of industrial uses for oil compositions disclosed herein include comprising part of a lubricating composition (U.S. Pat. No. 6,689,722; see also WO 2004/0009789A1); a fuel, e.g., biodiesel (U.S. Pat. No. 6,887,283; see also WO 2009/038108A1); record material for use in reprographic equipment (U.S. Pat. No. 6,310,002); crude oil simulant compositions (U.S. Pat. No. 7,528,097); a sealing composition for concrete (U.S. Pat. No. 5,647,899); a curable coating agent (U.S. Pat. No. 7,384,989); industrial frying oils; cleaning formulations (WO 2007/104102A1; see also WO 2009/007166A1); and solvents in a flux for soldering (WO 2009/069600A1). Oil compositions disclosed herein may also be used in industrial processes, for example, the production of bioplastics (U.S. Pat. No. 7,538,236); and the production of polyacrylamide by inverse emulsion polymerization (U.S. Pat. No. 6,686,417). Examples of cosmetic uses for oil compositions disclosed herein include use as an emollient in a cosmetic composition; as a petroleum jelly replacement (U.S. Pat. No. 5,976,560); as comprising part of a soap, or as a material in a process for producing soap (WO 97/26318; U.S Pat. No. 5,750,481; WO 2009/078857A1); as comprising part of an oral treatment solution (WO 00/62748A1); as comprising part of an ageing treatment composition (WO 91/11169); and as comprising part of a skin or hair aerosol foam preparation (U.S. Pat. No. 6,045,779). Oil compositions disclosed herein may also be used in medical applications. For example, oil compositions disclosed herein may be used in a protective barrier against infection (Barclay and Vega, “Sunflower oil may help reduce nosocomial infections in preterm infants.” Medscape Medical News <http://cme.medscape.com/viewarticle/501077>, accessed Sep. 8, 2009); and oil compositions high in omega-9 fatty acids may be used to enhance transplant graft survival (U.S. Pat. No. 6,210,700).

All references, including publications, patents, and patent applications, discussed herein are provided solely for their disclosure prior to the filing date of the present application. Nothing herein is to be construed as an admission that the inventors are not entitled to antedate such disclosure by virtue of prior invention.

The following examples are provided to illustrate certain particular features and/or aspects. These examples should not be construed to limit the disclosure to the particular features or aspects described.

### EXAMPLES

The oxidative and sensory stability of blended oil samples were evaluated over time, as determined by chemical and sensory tests. Samples of DowAgro Omega-9 Canola Oil (“DowAgro Canola Oil”) (marketed as NATREON™ by DowAgrosciences, Indianapolis, Ind.) were compared to commercially refined, bleached, and deodorized commodity canola oil (“Market Leader Canola Oil”). Some samples included DHA and/or tocopherol antioxidants.

### Example 1

### Blending of Oil

Oil blends were prepared on a weight basis. Market leader canola oil was obtained from POS Pilot Plant (Saskatoon, SK, Canada). DowAgro canola oil was obtained from Richardson International (Winnipeg, MB, Canada). Samples were prepared by blending approximately 50 g of DowAgro canola oil or market leader canola oil with DHA stock oil (Martek, Columbia, Md.) having a known content of DHA. The DHA stock oil was added to final concentrations of 0.5% or 1.0% for both DowAgro canola oil and market leader canola oil. In addition, DHA stock oil containing antioxidants (600 ppm of tocopherol) was added in some samples. Antioxidants were added to final concentrations of 1.0% or 0.5% for both DowAgro canola oil and market leader canola oil. Blended oils were stirred until uniform. The blends were stored in a gravity convection oven set at 50° C. Approximately 10 g aliquots were taken every 2 weeks and stored frozen until the different analysis described below were performed.

### Example 2

### Fatty Acid Methyl Esterase (FAME) Analysis of Oils

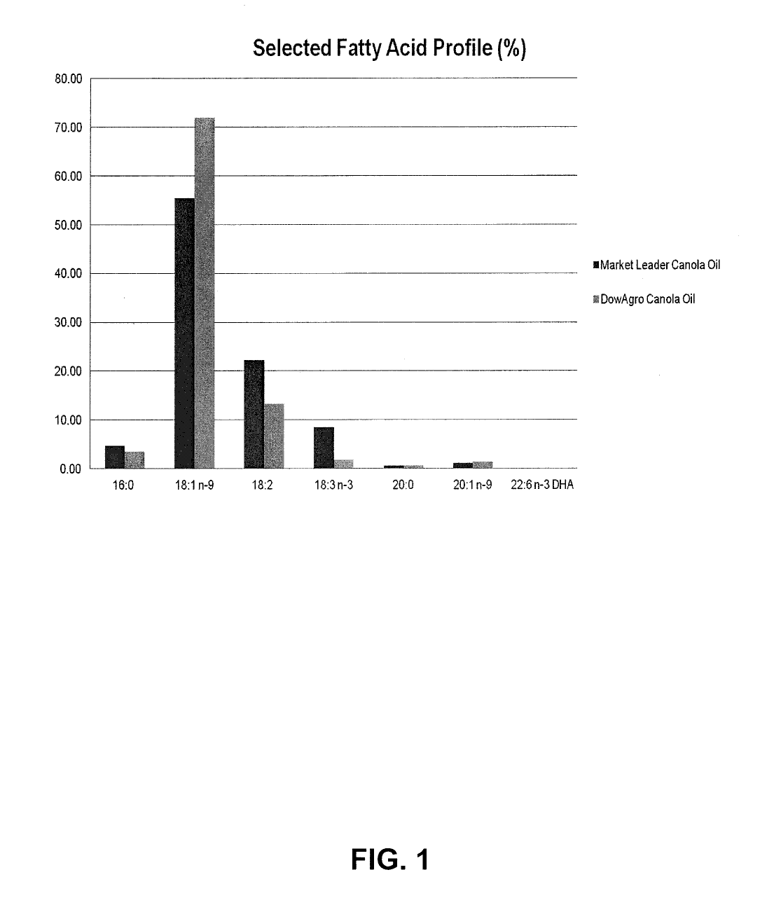

Experimental oil blends were analyzed for fatty acid content using the FAME method described in AOCS method Ce 2-66 (Preparation of Methyl Esters of Fatty Acids: Ce2-66(97). Official Methods and Recommended Practices of the AOCS, Fifth Edition—First Printing (including all changes 1993-1997); Dr. David Firestone—Editor: American Oil Chemist's Society, Champaign, Ill.). Oil samples were diluted to 20 mg oil/mL in heptane. Forty microliters (40 μl) of 1% sodium methoxide in methanol was added to each sample, vortexed, and incubated for 60 minutes at room temperature. One microliter (1 μl) of the resulting mixture was then injected on an Agilent 6890 GC™ equipped with a flame ionization detector (FID). Methyl ester reference standards were purchased from Nu-Chek-Prep, Inc. and used to identify the fatty acid peaks in each oil sample diluted to the same concentration as the samples (Nu-Chek Prep Inc.). The column used was a DB-23, 60-meter column with a 0.25-mm ID and 0.25-μm film thickness (Agilent Technologies). Oven temperature was set at 190° C. and maintained isothermally throughout the run. The inlet split ratio was 1:25 and the inlet temperature was 28° C. Hydrogen carrier gas flow rate was initially set at 3.0 mL/min for 0.3 minutes then ramped to 0.5 ml/min-4.0 ml/min, and held for 15.5 minutes. The hydrogen carrier gas flow rate was then reduced to 3.5 ml/min at a rate of 0.5 ml/min and held for the remaining run time. The detector temperature was set to 300° C. with a constant carrier gas make up of 20 mL/min, fuel hydrogen flow of 30 mL/min, and oxidizer flow of 400 mL/min. The fatty acid profile of DowAgro canola oil and market leader canola oil are illustrated in FIG. 1. Samples were stored at 50° C. and analyzed for trans-fatty acids and DHA content at two week intervals over eight weeks, as summarized in Tables 1 and 2, respectively.

TABLE 1
Trans-fat percentage in canola oil samples,
determined by FAME analysis.

| | % of trans-fat | | | | |
|---|---|---|---|---|---|
| | time | 2 wks, | 4 wks, | 6 wks, | 8 wks, |
| Sample | 0 | 50° C. | 50° C. | 50° C. | 50° C. |
| Market Leader Canola | 0.05 | 0.06 | 0.07 | 0.04 | 0.07 |
| (no DHA) | | | | | |
| Market Leader Canola + | 0.05 | 0.04 | 0.10 | 0.09 | 0.03 |
| 0.5% DHA (no antiox) | | | | | |
| Market Leader Canola + | 0.06 | 0.08 | 0.08 | 0.09 | 0.03 |
| 1% DHA (no antiox) | | | | | |
| Market Leader Canola + | 0.06 | 0.11 | 0.06 | 0.11 | 0.06 |
| 0.5% DHA (with antiox) | | | | | |
| Market Leader Canola + | 0.07 | 0.07 | 0.09 | 0.09 | 0.07 |
| 1% DHA (with antiox) | | | | | |
| DowAgro Canola control | 0.31 | 0.26 | 0.27 | 0.29 | 0.10 |
| (no DHA) | | | | | |
| DowAgro Canola + | 0.30 | 0.28 | 0.29 | 0.29 | 0.09 |
| 0.5% DHA (no antiox) | | | | | |
| DowAgro Canola + | 0.29 | 0.29 | 0.27 | 0.28 | 0.24 |
| 1% DHA (no antiox) | | | | | |
| DowAgro Canola + | 0.27 | 0.29 | 0.27 | 0.30 | 0.08 |
| 0.5% DHA (with antiox) | | | | | |
| DowAgro Canola + | 0.29 | 0.28 | 0.27 | 0.30 | 0.09 |
| 1% DHA (with antiox) | | | | | |

TABLE 2
DHA percentage in canola oil samples by
FAME analysis (nd = not determined).

| | % of DHA | | | | |
|---|---|---|---|---|---|
| | time | 2 wks, | 4 wks, | 6 wks, | 8 wks, |
| Sample | 0 | 50° C. | 50° C. | 50° C. | 50° C. |
| Market Leader Canola | nd | nd | nd | nd | nd |
| (no DHA) | | | | | |
| Market Leader Canola + | 0.53 | 0.55 | 0.53 | 0.52 | 0.49 |
| 0.5% DHA (no antiox) | | | | | |
| Market Leader Canola + | 1.07 | 1.04 | 1.05 | 1.02 | 0.91 |
| 1% DHA (no antiox) | | | | | |
| Market Leader Canola + | 0.58 | 0.55 | 0.59 | 0.58 | 0.51 |
| 0.5% DHA (with antiox) | | | | | |
| Market Leader Canola + | 1.08 | 1.05 | 1.07 | 1.03 | 0.95 |
| 1% DHA (with antiox) | | | | | |
| DowAgro Canola control | nd | nd | nd | nd | nd |
| (no DHA) | | | | | |
| DowAgro Canola + | 0.54 | 0.54 | 0.53 | 0.51 | 0.42 |
| 0.5% DHA (no antiox) | | | | | |
| DowAgro Canola + | 1.06 | 1.05 | 1.02 | 0.95 | 0.83 |
| 1% DHA (no antiox) | | | | | |
| DowAgro Canola + | 0.57 | 0.59 | 0.56 | 0.54 | 0.46 |
| 0.5% DHA (with antiox) | | | | | |
| DowAgro Canola + | 1.10 | 1.11 | 1.06 | 1.02 | 0.90 |
| 1% DHA (with antiox) | | | | | |

### Example 3

### RANCIMAT™ Study to Determine Oxidative Stability Index (OSI)

Aliquots of selected canola oil compositions were analyzed on a RANCIMAT™ (Metrohm, Herisau, Switzerland) at 110° C., following manufacturer's instructions. Three gram (3 g) aliquots of each oil sample were placed into labeled reaction vessels and an air inlet and cap was inserted into each vial. Collection vessels were filled with 70 mL of MILLI-Q™ water and placed onto the RANCIMAT™, and tubing was attached from the reaction vessel to the collection vessel. Once the temperature of 110° C. was reached, vials were inserted into the heat block and an air flow of 20 mL/min was initiated. The RANCIMAT™ method monitors the increase in conductivity in the collection vessels, and determines the oxidative stability index (OSI) breakpoint of the oil from the inflection point of the conductivity curve. Calculated OSI's at 110° C. are reported in Table 3.

TABLE 3
Oxidative Stability Index of canola oil samples
determined by RANCIMAT ™ analysis.

| | OSI @ 110° C. | | | | |
|---|---|---|---|---|---|
| | time | 2 wks, | 4 wks, | 6 wks, | 8 wks, |
| Sample | 0 | 50° C. | 50° C. | 50° C. | 50° C. |
| Market Leader | 10.22 h | 7.10 h | 5.65 h | 3.59 h | 1.67 h |
| Canola (no DHA) | | | | | |
| Market Leader | 9.37 h | 5.76 h | 4.45 h | 2.62 h | <1 h |
| Canola + 0.5% | | | | | |
| DHA (no | | | | | |
| antioxidants) | | | | | |
| Market Leader | 8.53 h | 4.35 h | 3.61 h | 2.40 h | 1.04 h |
| Canola + 1% | | | | | |
| DHA (no | | | | | |
| antioxidants) | | | | | |
| Market Leader | 9.80 h | 5.78 h | 4.57 h | 3.20 h | 1.16 h |
| Canola + 0.5% | | | | | |
| DHA (with | | | | | |
| antioxidants) | | | | | |
| Market Leader | 9.08 h | 5.19 h | 4.06 h | 3.07 h | 1.25 h |
| Canola + 1% | | | | | |
| DHA (with | | | | | |
| antioxidants) | | | | | |
| DowAgro Canola | 18.46 h | 15.64 h | 10.51 h | 5.50 h | 2.62 h |
| control (no DHA) | | | | | |
| DowAgro Canola + | 15.25 h | 12.33 h | 7.88 h | 4.36 h | 1.15 h |
| 0.5% DHA (no | | | | | |
| antioxidants) | | | | | |
| DowAgro Canola + | 13.44 h | 8.91 h | 6.18 h | 3.62 h | 1.22 h |
| 1% DHA (no | | | | | |
| antioxidants) | | | | | |
| DowAgro Canola + | 16.13 h | 13.25 h | 9.04 h | 5.28 h | 2.20 h |
| 0.5% DHA (with | | | | | |
| antioxidants) | | | | | |
| DowAgro Canola + | 14.03 h | 10.72 h | 7.46 h | 4.67 h | 1.62 h |
| 1% DHA (with | | | | | |
| antioxidants) | | | | | |

The results show a decrease in OSI score over time in all samples. Longer periods of storage resulted in greater instability and more oxidation of the canola oil, producing a lower OSI score. However, DowAgro canola oil, with or without DHA or added antioxidants, was more stable than the market leader canola oil over longer periods of storage. For example, the market leader canola oil at the initial time point (“Time 0” in Table 3) produced an OSI score of 10.22 hours, which is significantly lower than the DowAgro oil at the initial time point (“Time 0” in Table 1) with an OSI score of 18.46 hours. After 8 weeks of storage at 50° C., the DowAgro oils continued to show less oxidation, producing significantly higher OSI scores, as compared to market leader canola oil. The DowAgro canola oil yielded an OSI score of 2.62 hours after 8 weeks of storage at 50° C. This OSI score was significantly higher than the market leader canola oil OSI score of 1.67 hours after 8 weeks of storage at 50° C. The trend of reduced oxidation was observed in all DowAgro canola samples, compared to market leader canola oil samples under the same conditions.

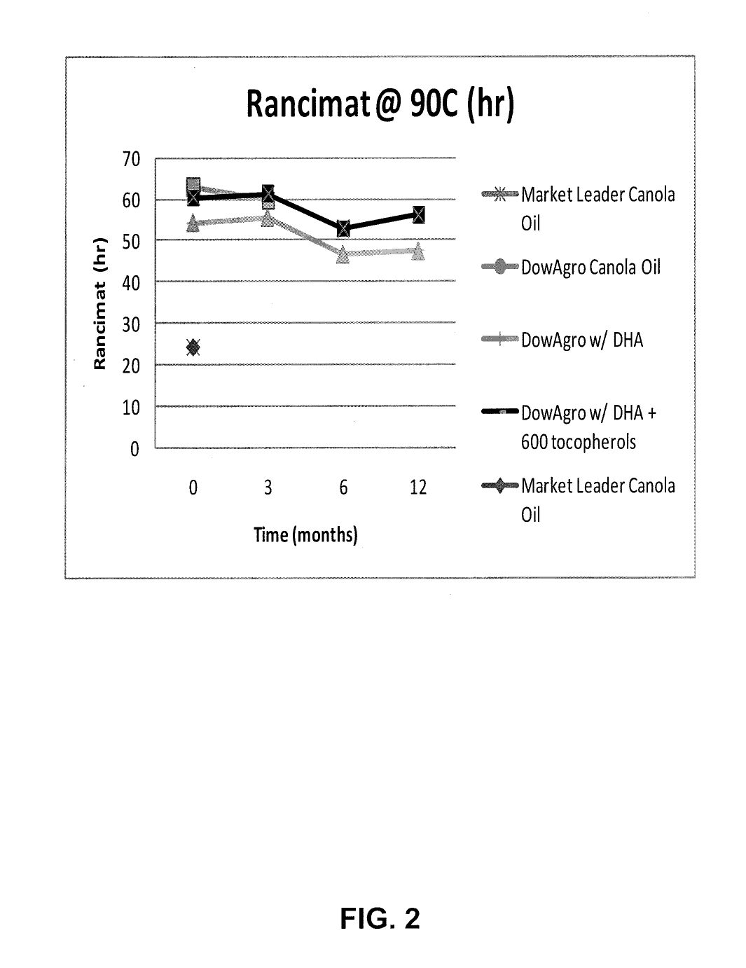

RANCIMAT™ analysis was repeated as indicated above, but the operating temperature was set to 90° C. (FIG. 2), and samples were analyzed over 12 months of storage. DowAgro canola oil samples, with or without DHA or tocopherols, demonstrated higher OSI scores (thus, better oxidative stability) than market leader canola oil at the initial time point. Over a 12 month storage period, all DowAgro canola oil samples, with or without DHA or added tocopherols, demonstrated similar oxidative stability trends.

### Example 4

### Peroxide Value Analysis of Oils

The peroxide value (PV) was determined for the oil samples. Market leader canola oil, with and without DHA, was compared to DowAgro canola oil, with and without DHA and added tocopherols. PV is calculated by determining all substances which oxidize potassium iodide, in terms of milliequivalents of peroxide per 1,000 g of sample. These substances are generally assumed to be peroxides or other similar products of fat oxidation. The American Oil Chemists' Society “Peroxide Value Acetic Acid—Chloroform Method” Cd8-53 (1997) was adapted to include the use of a METROHM 702™ autotitrator. A blank titration was initially run at the beginning of each shift or when any change occurred to the system. The autotitrator was set according to the manufacturer's recommended equipment parameters. Thirty milliliter (30 mL) of acetic acid/chloroform solution was added to a titration beaker containing 5 g of an oil sample, and 500 μl of KI solution was added while the solution swirled on a titrator swirl plate. The solution was allowed to stand, with occasional shaking, for exactly one minute. Next, 30 mL of distilled water was added to the solution and the solution was swirled on a titrator swirl plate for one minute. The autotitrator electrode was immersed in the solution, and the results were recorded and compared to known sodium thiosulfate solution molar standards and a blank control. Peroxide value, as milliequivalents of peroxide per 1000 g sample, was calculated by the autotitrator using the formula:

$$PV = \frac{( EP 1 - C 30 ) * C 31 * C 01}{C 00}$$

where:

EP1=Titration of the sample (mL)

C30=Titration of the blank (mL)

C31=Normality of the sodium thiosulfate solution

C01=1000 (constant of 1000 g of sample)

C00=Weight of the sample, g

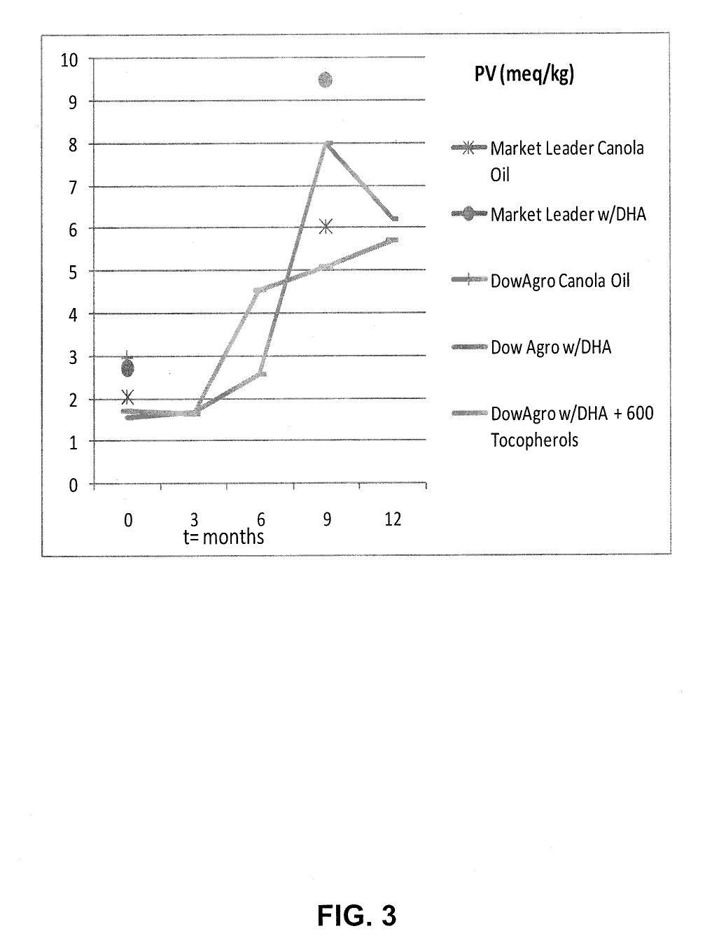

Peroxide value results are illustrated in FIG. 3. DowAgro canola oil, with or without DHA, was associated with lower peroxide values than market leader canola oil. The addition of tocopherols to DowAgro canola oil with DHA appeared to have little effect on PV values, although a slightly higher PV value was noted at 6 months, and a slightly lower PV value was noted at 9 months, with the addition of tocopherols. Lower peroxide values are indicative of a lower level of rancidity in the oil samples. Higher values indicate greater amounts of rancidity, which is an undesirable characteristic in oil products. DowAgro canola oil thus experienced less oxidation and rancidity during the incubation periods, compared to market leader canola oil.

### Example 5

### p-Anisidine Value Analysis of Oils

The p-anisidine value (pAnV) was determined for the oil samples. Market leader canola, with and without DHA, was compared to DowAgro canola, with and without DHA and added tocopherols. The American Oil Chemists' Society Anisidine Value Method Cd18-90 (1997) method was used to analyze the samples. In the presence of acetic acid, p-anisidine reacts with aldehydic compounds in oils or fats, forming yellowish reaction products. The pAnV is determined by measuring absorbance of a pAnV reaction at 350 nm. The intensity of the products formed depends not only on the amount of aldehydic compounds present, but also on their structure. It has been found that a double bond in the carbon chain conjugated with the carbonyl double bond increases the molar absorbance four to five times. This indicates that 2-alkenals and dienals, especially, will contribute substantially to the value. Oil samples were weighed into a 25 mL labeled volumetric flask and the weight was recorded. The samples were dissolved and diluted to volume with isooctane. A stopper was placed on top of the flasks and the flasks were shaken well. Approximately 2 mL of the isooctane was transferred into a clean 1.00 cm cuvette. The absorbance of the solutions was measured using spectrophotometry at 350 nm. The procedure was repeated using 5 mL of isooctane, which was transferred to dilute the samples. Exactly 1 mL of the p-anisidine solution was added to each set of samples, and the tubes were shaken vigorously for ten seconds. After ten minutes of reaction time, the solution was transferred to the 1.00 cm cuvettes. These samples were measured by a spectrophotometer at 350 nm and compared to a “blank.” The pAnV was calculated using the formula:

$$pAnV = \frac{25 * ( 1.2 As - Ab )}{m}$$

where:
As=absorbance of the sample after reaction with the p-anisidine reagent, as measured by the spectrophotometer reading;
Ab=initial absorbance of the solution; and
m=mass of the test portion in grams.

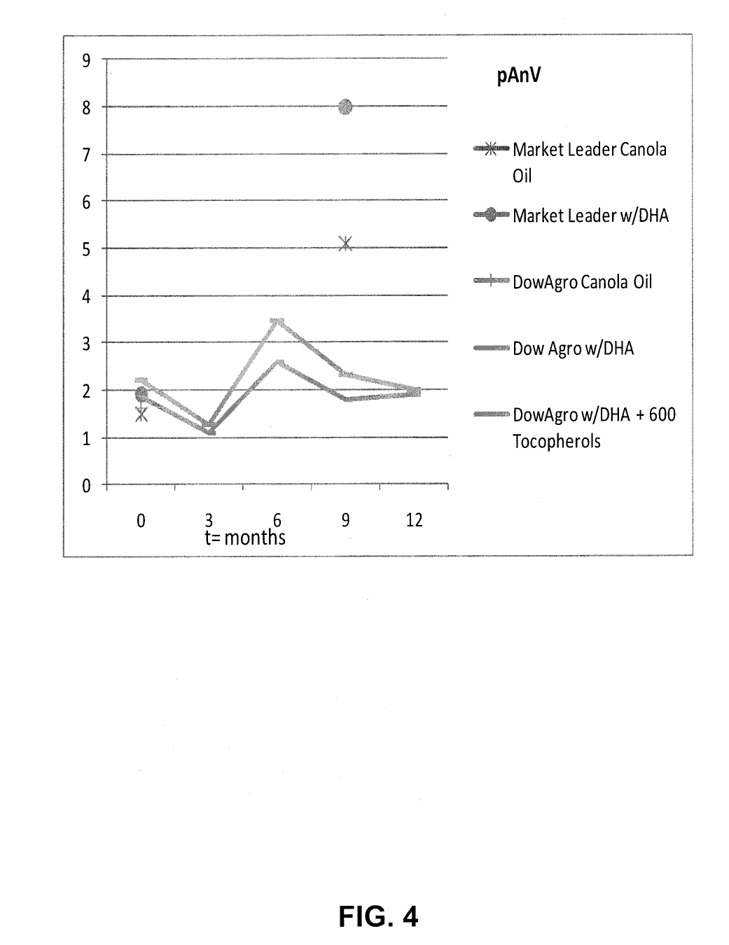

The p-anisidine results are illustrated in FIG. 4. DowAgro canola oil pAnV values were lower than market leader canola oil values at 0 and 9 months. Lower p-anisidine values are indicative of less aldehyde production occurring within the oil samples. Higher values indicate more aldehyde production, which is an undesirable characteristic in oil products. Table 4 summarizes the oxidative stability data (including RANCIMAT™, PV, and pAnV) for DowAgro canola oil, with and without DHA and added tocopherols, and market leader canola oil, with and without DHA.

TABLE 4
Oxidative stability of DowAgro Canola Oil, with and without DHA or tocopherols.

| | | | | | | DowAgro |
|---|---|---|---|---|---|---|
| | | | | | | Omega-9 |
| | | Market | Market | | DowAgro | Canola Oil |
| | | Leader | Leader | DowAgro | Omega-9 | w/DHA + |
| | Test | Canola | Canola Oil | Omega-9 | Canola Oil | 600 ppm |
| Sample | Schedule | Oil | w/DHA | Canola Oil | w/DHA | Tocopherols |
| mg/g DHA | T₀ | 0.00 | 2.68 | 0.00 | 2.53 | 2.58 |
| mg/14 g DHA | T₀ | N/A | 37.5 | N/A | 35 | 36 |
| Tocopherols (ppm) | T₀ | 734 | N/A | 533 | 537 | 1,118 |
| RANCIMAT ™ @ | T₀ | 24.1 | N/A | 62.9 | 54.3 | 60.3 |
| 90° C. (Hr) | | | | | | |
| PV (meq/kg) | T₀ | 2.04 | 2.72 | 2.95 | 1.57 | 1.70 |
| pAnV | T₀ | 1.50 | 1.90 | 1.60 | 1.85 | 2.20 |
| FFA (%) | T₀ | 0.05 | 0.05 | <0.05 | <0.05 | <0.05 |
| RANCIMAT ™ @ | T₃ₘₒₙₜₕ | N/A | N/A | 59.6 | 55.5 | 61.3 |
| 90° C. (Hr) | | | | | | |
| PV (meq/kg) @ RT | T₃ₘₒₙₜₕ | N/A | N/A | N/A | 1.69 | 1.62 |
| pAnV @ RT | T₃ₘₒₙₜₕ | N/A | N/A | N/A | 1.10 | 1.25 |
| FFA (%) @ RT | T₃ₘₒₙₜₕ | N/A | N/A | N/A | <0.05 | <0.05 |
| RANCIMAT ™ @ | T₆ₘₒₙₜₕ | N/A | N/A | N/A | 46.7 | 52.8 |
| 90° C. (Hr) | | | | | | |
| PV (meq/kg) @ RT | T₆ₘₒₙₜₕ | N/A | N/A | N/A | 2.55 | 4.55 |
| pAnV @ RT | T₆ₘₒₙₜₕ | N/A | N/A | N/A | 2.60 | 3.47 |
| FFA (%) @ RT | T₆ₘₒₙₜₕ | N/A | N/A | N/A | <0.05 | <0.05 |
| RANCIMAT ™ @ | T₉ₘₒₙₜₕ | N/A | N/A | N/A | N/A | N/A |
| 90° C. (Hr) | | | | | | |
| PV (meq/kg) @ RT | T₉ₘₒₙₜₕ | 6.03 | 9.48 | N/A | 7.99 | 5.09 |
| pAnV @ RT | T₉ₘₒₙₜₕ | 5.09 | 7.99 | N/A | 1.80 | 2.30 |
| FFA (%) @ RT | T₉ₘₒₙₜₕ | N/A | N/A | N/A | <0.05 | <0.05 |
| pAnV @ RT | T₁₂ₘₒₙₜₕ | N/A | N/A | N/A | 1.9 | 2.0 |
| PV (meq/kg) | T₁₂ₘₒₙₜₕ | N/A | N/A | N/A | 6.2 | 5.7 |
| FFA (%) | T₁₂ₘₒₙₜₕ | N/A | N/A | N/A | <0.05 | <0.05 |
| RANCIMAT ™ @ | T₁₂ₘₒₙₜₕ | N/A | N/A | N/A | 47.48 | 56.14 |
| 90° C. (Hr) | | | | | | |
| Tocopherols (ppm) | T₁₂ₘₒₙₜₕ | N/A | N/A | N/A | 461 | 1032 |

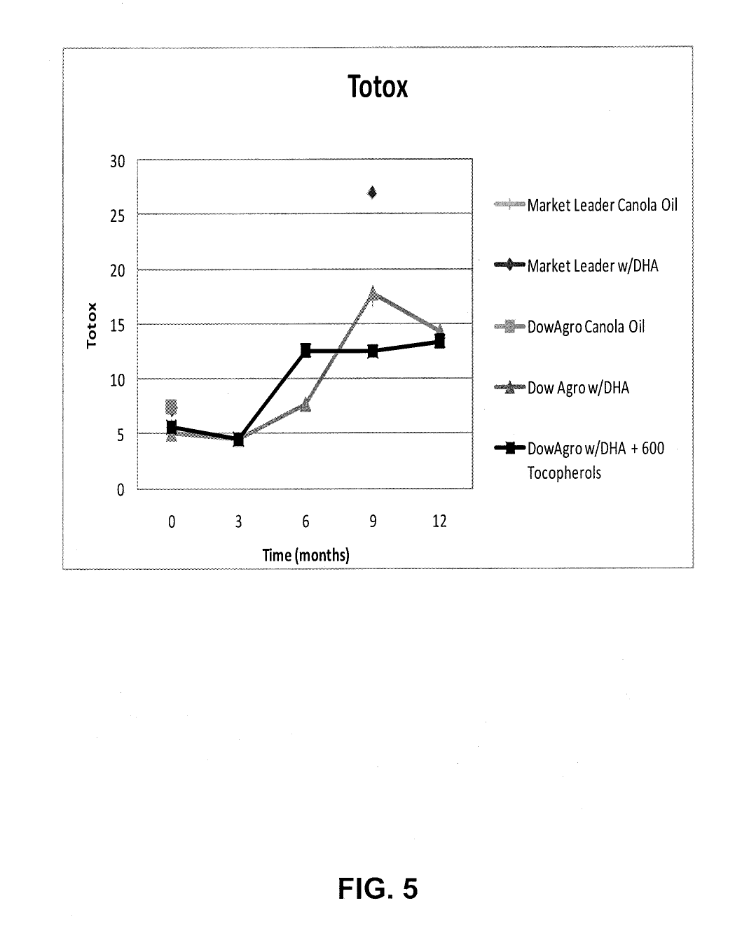

A Totox value was also calculated for DowAgro canola oil samples, with and without DHA and added tocopherols, and market leader canola oil, with and without DHA, using the formula TV=AV+2PV. FIG. 5. The Totox value indicates an oil's overall oxidation state. Lower Totox values are associated with improved oxidative stability. The oxidative stability data demonstrates that DowAgro canola oil with DHA exhibits comparable or superior oxidative stability to market leader canola oil. This may be related to DowAgro canola oil's higher oleic acid content, or other factors.

### Example 6

### Schaal Oven Test

An informal sensory screening for rancidity was conducted on canola oil compositions using the Schaal Oven Storage Stability Test. The Schaal Oven Test is used to rapidly estimate time to rancidity for fats, oils, and baked goods such as crackers and pie crusts, by incubating samples in an oven at elevated temperatures for extended periods of time. Samples tested were market leader canola oil without DHA; market leader canola oil with DHA; DowAgro Canola oil with DHA; and DowAgro Canola oil with DHA and added tocopherols (600 ppm). All samples were rancid after one week of storage at 60° C.

### Example 7

### Volatile Profiles in Processed Oil Samples by E-Nose Analysis, Stored at 130° F.

A comparison of volatile compounds emitted by DowAgro Omega-9 canola oil and market leader canola oil samples stored at elevated temperature was made using the Analytical Technologies ALPHA MOS FOX 4000 system™ (Alpha MOS, Hanover, Md.), herein described as the “E-Nose.” The E-Nose is equipped with 18 metal oxide sensors, giving it a wide range of odor detection capability. Odors result from complex mixtures of hundreds, if not thousands, of compounds emitted by the test oil samples, and these odors are detected by the E-Nose. The data produced from the E-Nose can be used to identify and discriminate “off” odors and irregular odors from shelf life stability studies.

E-nose analysis was completed on the following samples: DowAgro Omega-9 canola oil containing no DHA; DowAgro Omega-9 canola oil containing 0.5% DHA; DowAgro Omega-9 canola oil containing 1.0% DHA; market leader canola oil containing no DHA, market leader canola oil containing 0.5% DHA, and market leader canola oil containing 1.0% DHA. Five to ten grams (5 to 10 g) of the oil samples were stored at 130° F. in a clear glass bottle. Aliquots were removed at an initial time point (i.e. 0 Day Incubation), 30 days, and 60 days and analyzed using the E-nose. Analytical conditions used to measure the samples are described in Table 5.

TABLE 5
Analytical conditions for Alpha MOS system.

| Headspace | Quantity of sample in the vial: | g | |
|---|---|---|---|
| generation | Total volume of the vial: | 10 | ml |
| | Headspace generation time: | 30 | min |
| | Headspace generation temperature: | 100° | C. |
| | Agitation speed: | 500 | rpm |
| Headspace | Carrier gas: | synthetic dry air | |
| injection | Injected volume: | 2.5 | ml |
| | Injection speed: | 2.5 | ml/sec |
| | Total volume of the syringe: | 5 | ml |
| | Syringe temperature: | 110° | C. |
| Acquisition | Acquisition time: | 120 | sec |
| parameters | Acquisition delay: | 1080 | sec |
| | Flushing time: | 120 | sec |

| | | |
|---|---|---|
| Sensor | Sensors chamber 1: | LY2/LG, LY2/G, |
| Chamber | | LY2/AA, LY2/GH, |
| Settings | | LY2/gCTL, LY2/gCT |
| | Sensors chamber 2: | T30/1, P10/1, |
| | | P10/2, P40/1, |
| | | T70/2, PA/2 |
| | Sensors chamber 3: | P30/1, P40/2, |
| | | P30/2, T40/2, |
| | | T40/1, TA/2 |

To analyze the oils, 1.0 ml of each sample was injected into the E-nose using a 5.0 mL heated syringe. The incubator oven has 6 heated positions for 2, 10 or 20 mL vials with a heating range of 35-200° C., in 1° C. increments. In addition, the incubator has an orbital shaker to mix the sample while heating. The system uses a TOC (Total Organic Carbon) gas filter to produce synthetic dry air flow for the system. A diagnostic sample set was run weekly to assure that the sensors were in working order and an autotest was performed weekly to insure that the autosampler and temperatures in the chambers were functioning properly.

Using this method, a Principle Component Analysis (PCA) graph was generated to evaluate DowAgro Omega-9 canola oil and market leader canola oil containing DHA. The results of the E-nose reading are shown in Table 6 and Table 7. These results provide the E-nose readings of the odor profiles for the four oil types after 30 and 60 days of incubation. The odor profiles of both the DowAgro Omega-9 canola oil and market leader canola oil containing DHA increased over time. However, the DowAgro Omega-9 canola oil produced a lower odor profile at the 30 day and 60 day time point, as compared to market leader canola oil.

TABLE 6
E-Nose Aroma Map for 0.5% DHA in market leader canola oil
and DowAgro Omega-9 canola oil stored at 130° F. The
results were produced with a discrimination factor of 97%.

| | 0 Day Incubation | | |
|---|---|---|---|
| | (Initial Time | 30 Day | 60 Day |
| Sample | Point) | Incubation | Incubation |
| Market leader Canola | −0.00580 (odor | 0.222 (odor | 0.354 (odor |
| control (no DHA) | units) | units) | units) |
| Market leader Canola + | −0.0060 (odor | 0.296 (odor | 0.401 (odor |
| 0.5% DHA (no | units) | units) | units) |
| antioxidants) | | | |
| DowAgro Omega-9 | 0.00539 (odor | 0.121 (odor | 0.312 (odor |
| Canola control (no | units) | units) | units) |
| DHA) | | | |
| DowAgro Omega-9 | 0.00516 (odor | 0.192 (odor | 0.355 (odor |
| Canola + 0.5% DHA | units) | units) | units) |
| (no antioxidants) | | | |

TABLE 7
E-Nose Aroma Map for 1.0% DHA in market leader canola oil
and DowAgro Omega-9 canola oil stored at 130° F. The
results were produced with a discrimination factor of 94%.

| | 0 Day Incubation | | |
|---|---|---|---|
| | (Initial Time | 30 Day | 60 Day |
| Sample | Point) | Incubation | Incubation |
| Market leader Canola | −0.0043 (odor | 0.310 (odor | 0.464 (odor |
| control (no DHA) | units) | units) | units) |
| Market leader Canola + | −0.0024 (odor | 0.443 (odor | 0.475 (odor |
| 1.0% DHA (no | units) | units) | units) |
| antioxidants) | | | |
| DowAgro Omega-9 | 0.0043 (odor | 0.203 (odor | 0.401(odor |
| Canola control (no | units) | units) | units) |
| DHA) | | | |
| DowAgro Omega-9 | 0.0160 (odor | 0.354 (odor | 0.460 (odor |
| Canola + 1.0% DHA | units) | units) | units) |
| (no antioxidants) | | | |

### Example 8

### Volatile Profiles in Processed by E-Nose Analysis, Stored at 75° F.

E-nose analysis was completed on oil samples stored at 75° F., using the method described in Example 6. The following samples were analyzed: DowAgro Omega-9 canola oil containing no DHA; DowAgro Omega-9 canola oil containing 0.5% DHA; DowAgro Omega-9 canola oil containing 1.0% DHA; Market leader canola oil containing no DHA; Market leader canola oil containing 0.5% DHA; and Market leader canola oil containing 1.0% DHA. Five to ten grams (5 to 10 g) of the oil samples were stored at 75° F. in a clear glass bottle. Aliquots of these samples were removed at an initial time point (i.e. 0 day), 60, 120, and 360 days, and evaluated using the E-nose. The results of the E-nose readings are shown in Tables 8 and 9. The odor profiles of the DowAgro Omega-9 canola oil and Market leader canola oil containing DHA increased over time. However, the DowAgro Omega-9 canola oil produced a lower odor profile at the 2, 4 and 6 month time points, as compared to the Market leader canola oil.

TABLE 8
E-Nose Aroma Map for 0.5% DHA in Market leader canola oil
and 0.5% DHA in DowAgro canola oil stored at 75° F.
Results were produced with a discrimination factor of 94%.

| | 0 Day | 2 Month | 4 Month | 6 Month |
|---|---|---|---|---|
| | Incubation | Incubation | Incubation | Incubation |
| | (Initial Time | (Initial Time | (Initial Time | (Initial Time |
| Sample | Point) | Point) | Point) | Point) |
| Market leader Canola control | −0.0053 (odor | −0.0096 (odor | 0.16 (odor | 0.18 (odor |
| (no DHA) | units) | units) | units) | units) |
| Market leader Canola + 0.5% | −0.0053 (odor | 0.051 (odor | 0.18 (odor | 0.19 (odor |
| DHA (no antiox) | units) | units) | units) | units) |
| Omega-9 Canola control (no | 0.0035 (odor | 0.028 (odor | 0.094 (odor | 0.087 (odor |
| DHA) | units) | units) | units) | units) |
| DowAgro Omega-9 Canola + | 0.0034 (odor | 0.0046 (odor | 0.078 (odor | 0.14 (odor |
| 0.5% DHA (no antiox) | units) | units) | units) | units) |

TABLE 9
E-Nose Aroma Map for 1.0% DHA in Market leader canola oil
and 1.0% DHA in DowAgro canola oil stored at 75° F.
Results were produced with a discrimination factor of 77%.

| | 0 Day | 2 Month | 4 Month | 6 Month |
|---|---|---|---|---|
| | Incubation | Incubation | Incubation | Incubation |
| | (Initial Time | (Initial Time | (Initial Time | (Initial Time |
| Sample | Point) | Point) | Point) | Point) |
| Market leader Canola control | −0.0072 (odor | −0.015 (odor | 0.16 (odor | 0.27 (odor |
| (no DHA) | units) | units) | units) | units) |
| Market leader Canola + 1.0% | −0.0057 (odor | −0.022 (odor | 0.29 (odor | 0.31 (odor |
| DHA (no antiox) | units) | units) | units) | unit |
| DowAgro Omega-9 Canola | 0.0064 (odor | 0.02 (odor | 0.08 (odor | 0.1 (odor |
| control (no DHA) | units) | units) | units) | units) |
| DowAgro Omega-9 Canola + | 0.0068 (odor | 0.036 (odor | 0.21 (odor | 0.27 (odor |
| 1.0% DHA (no antiox) | units) | units) | units) | units) |

### Example 9

### Sensory Stability Tests

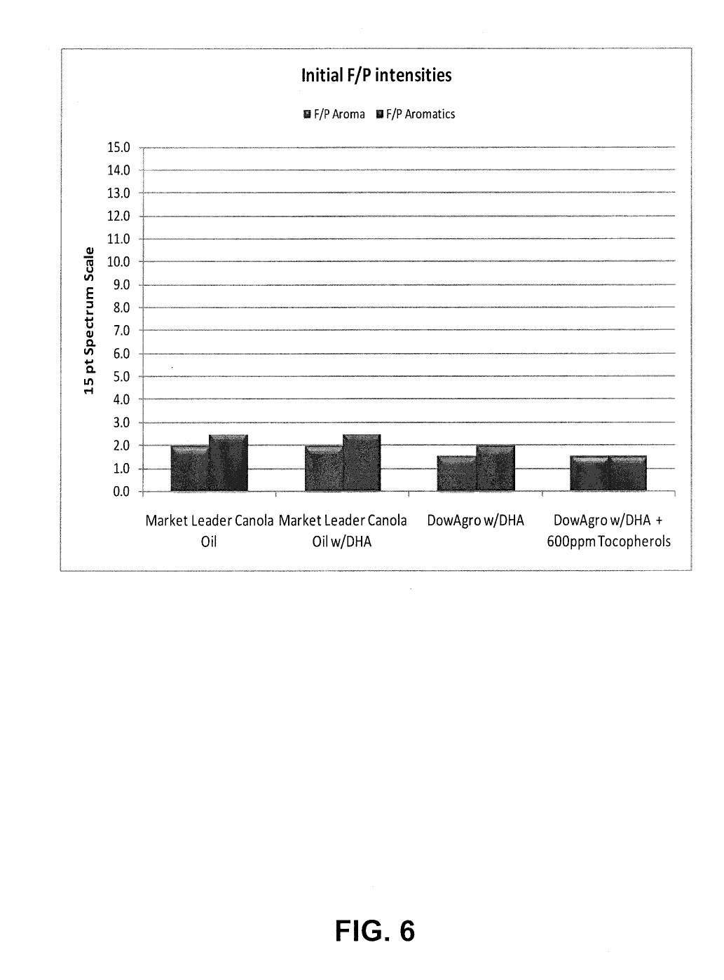

Sensory studies were completed to compare the DowAgro Omega-9 canola oil, with and without DHA and added antioxidants, to market leader canola oil, with and without DHA. The results of the sensory tests were determined by a group of panelists which ranked the intensity of the fishy/painty aroma and aromatic attributes of the oils on a 15 pt SPECTRUM™ scale. On this scale, a score of 0 indicates no aroma/aromatics, 1-3 is “low”; 4-6 is “low-medium”; 7-8 is “medium”; 9-11 is “medium high”; 12-14 is “high”; and 15 is “very high.” A preliminary study demonstrated that all samples produced low fishy/painty aroma and aromatics at time zero. FIG. 6.

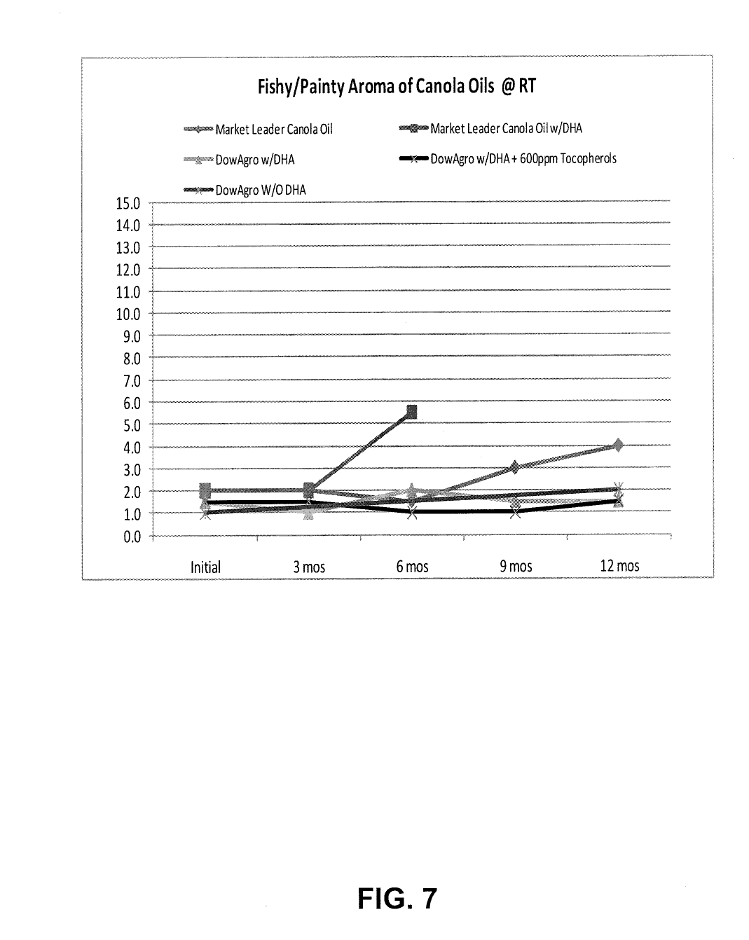

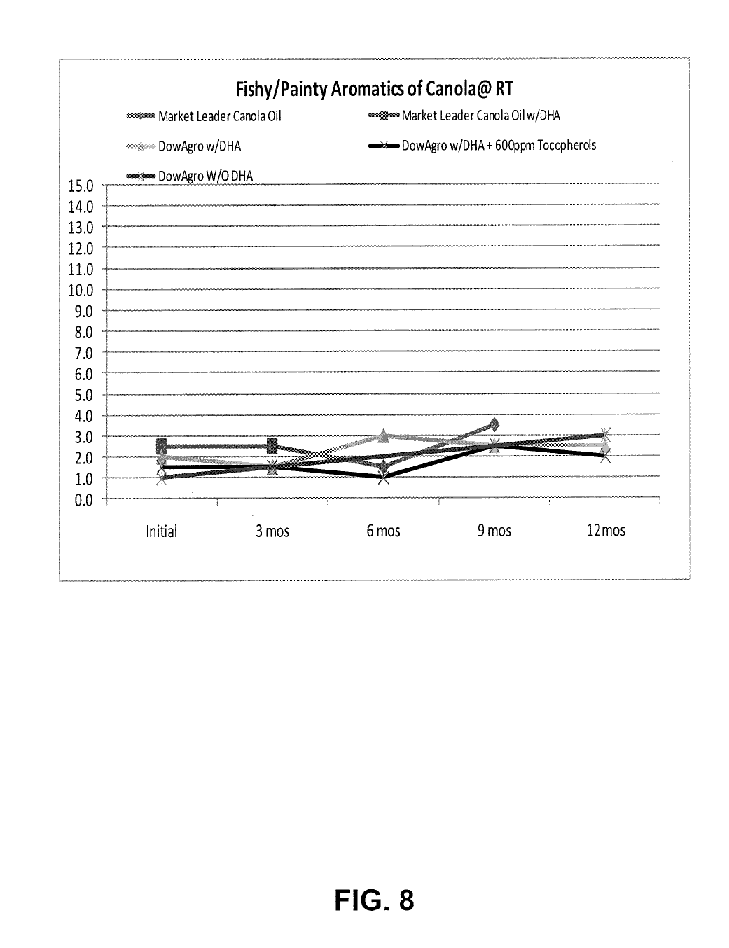

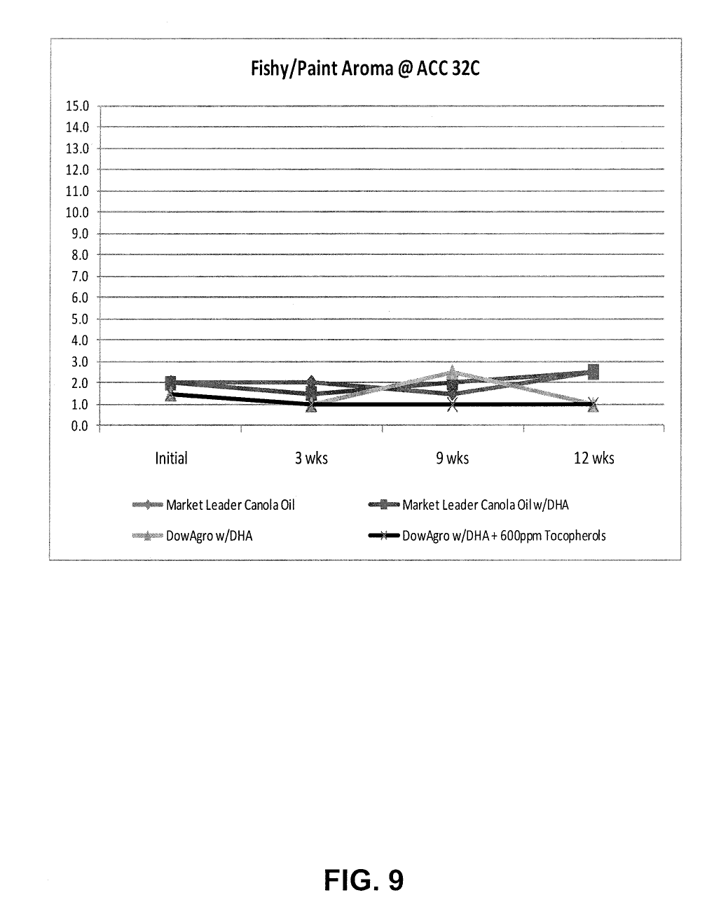

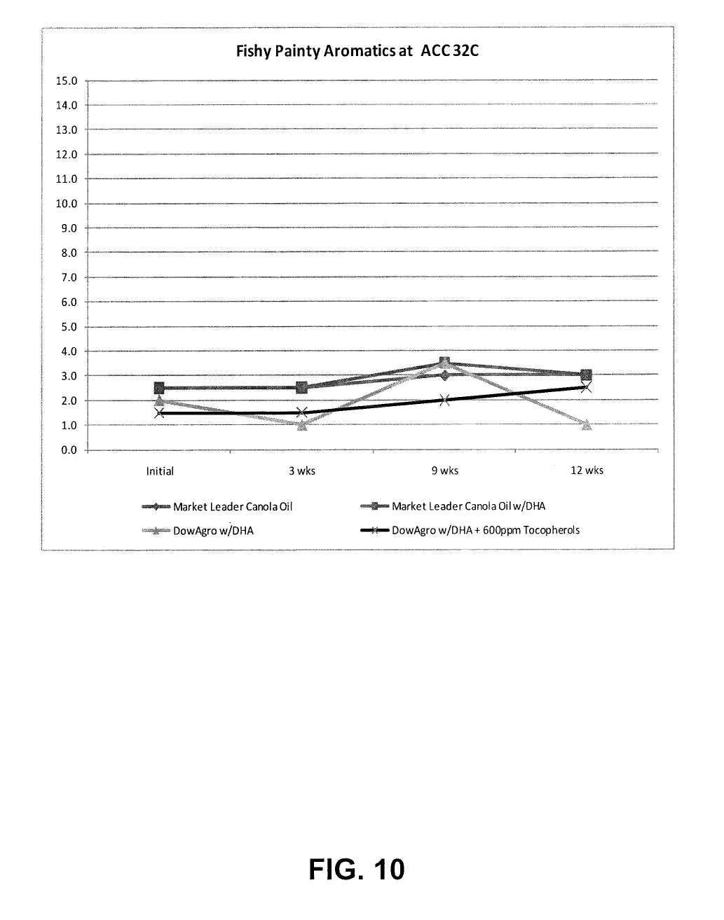

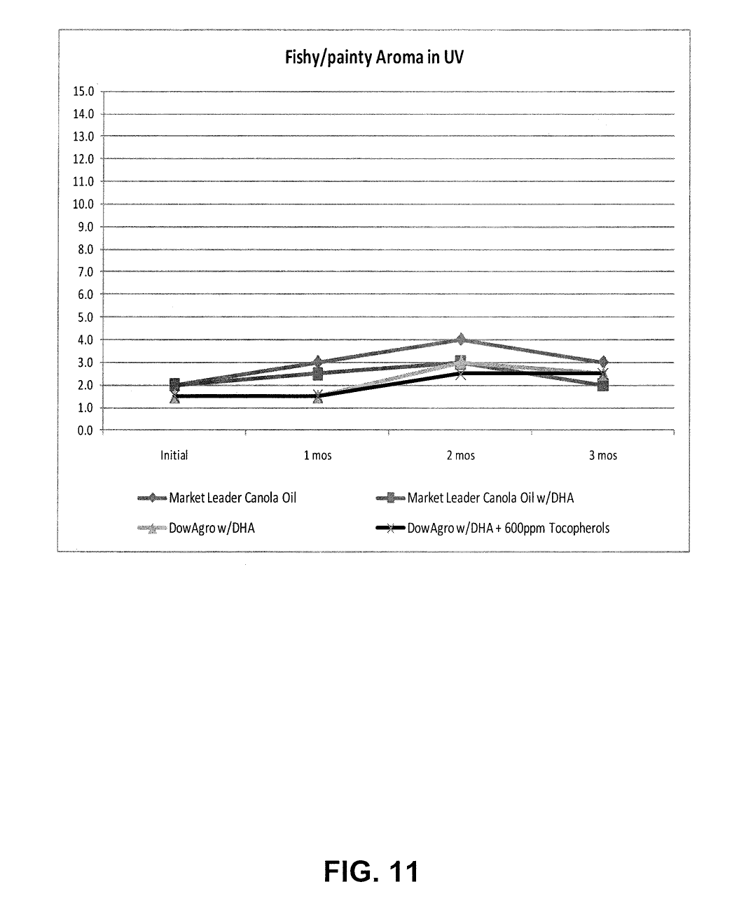

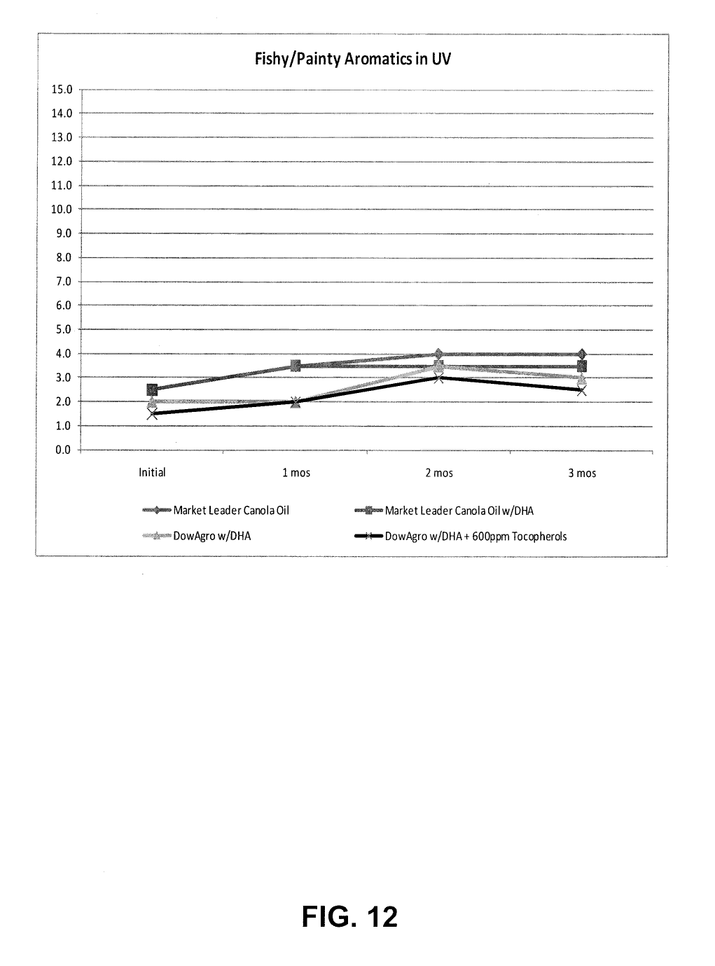

DowAgro Omega-9 and market leader canola oils were then subjected to an array of different storage conditions over several weeks/months. In the first study, the oil samples were stored in ambient (room temperature) conditions for zero months, six months, nine months, twelve months, or fifteen months. FIGS. 7 and 8. A second study compared oil samples stored at 32° C. for zero weeks, three weeks, nine weeks, or twelve weeks. FIGS. 9 and 10. A third study compared oil samples stored while being exposed to ultra violet light for one month, two months, and three months. FIGS. 11 and 12. The results of all three studies indicate that the DowAgro Omega-9 canola oil, with and without DHA and antioxidants, exhibited comparable fishy/painty aroma and aromatic production, compared to market leader canola oil, with and without DHA. Overall, of the samples tested at nine months, three of the four canola oil samples (Market Leader Canola Oil without DHA; DowAgro Canola Oil with DHA added; and DowAgro Canola Oil with DHA and tocopherols added) performed similarly throughout the course of the studies. The Market Leader Canola Oil with DHA sample, however, developed significant “off” notes (primarily painty/plastic/solvent-like) at T=6M and was discontinued from testing at T=9M. No significant fishy or painty aroma or aromatics were produced in any of the remaining samples at nine months under ambient (room temperature) conditions.

### Example 10

### Food Application Studies of Oils

Foods containing DowAgro Omega-9 canola oil with DHA, with and without antioxidants, were prepared, and the sensory outcomes were compared to the same foods prepared with market leader canola DHA oil. Oil stored for three months in a gravity convection oven set at 50° C. was compared to fresh oil. The recipes used for the preparation of the food (Table 9) were adopted from the William-Sonoma website and William-Sonoma cookbook. Final food products were sampled at room temperature by a panelist, and the overall sensory outcome was compared. A Difference From Control (DFC) method was used to measure outcomes. A panel scored the differences in taste of the hash browns, vinaigrette salad dressing, or muffins using a 6 point scale, as shown in Table 10. A DFC value of zero means that the panel noted no difference between the samples tested.

TABLE 10
6 pt Degree of Difference from Control (DFC) scale

| | Very | | | | | |
|---|---|---|---|---|---|---|
| No | Slight/ | | | | | Very Large |
| Difference | Trace | Slight | Moderate | Definite | Large | Difference |
| 0 | 1 | 2 | 3 | 4 | 5 | 6 |

Foods were prepared as described in Table 11. Sample sizes were weighed and served to the panelists for evaluation. Panelists were instructed on how to evaluate the samples.

TABLE 11
Recipes used for the sensory outcome trials of the food products prepared
with DowAgro Omega-9 canola oil that contained the addition of DHA.

| Potatoes: hash browns | | |
|---|---|---|
| (shredded frozen potatoes) | Muffins: Oat-bran muffins | Green salad with vinaigrette |
| Potatoes were the Ore-Ida | 2 cups oat bran (185 g) | ½ pound (0.226 kg) of salad |
| COUNTRY STYLE ™ | | fresh greens (about 8 cups) |
| shredded hash browns | | |
| Use 14 g oil with 1 cup (240 | 1 cup all purpose flour (155 g) | 2 tablespoons (30 ml) red wine |
| ml) of shredded potatoes | | vinegar |
| Potatoes were fried | ½ cup firmly packed sugar | 1 1/2 teaspoons (7.5 ml) Dijon |
| | (105 g) | mustard |
| | 4 teaspoons (20 ml) baking | ⅛ teaspoon (0.625 ml) salt |
| | powder | |
| | 1 teaspoon (5 ml) ground | Pinch of freshly ground |
| | cinnamon | pepper |
| | ½ teaspoon (2.5 ml) salt | 6 tablespoons (90 ml) canola |
| | | oil blend |
| | 1¼ cups milk (310 ml) | Vinaigrette dressing was |
| | | combined with the salad and |
| | | served. |
| | 2 eggs | |
| | ⅓ cup canola oil blend (80 ml) | |
| | ½ cup raisins (90 g) | |
| | Muffins were baked until | |
| | done in a 425° F. (214° C.) | |
| | oven temperature | |

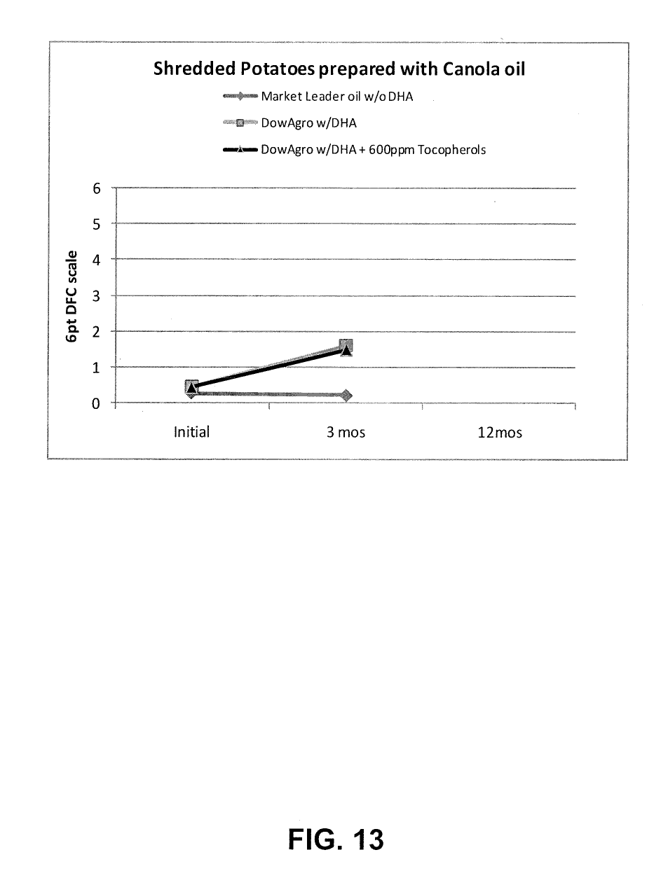

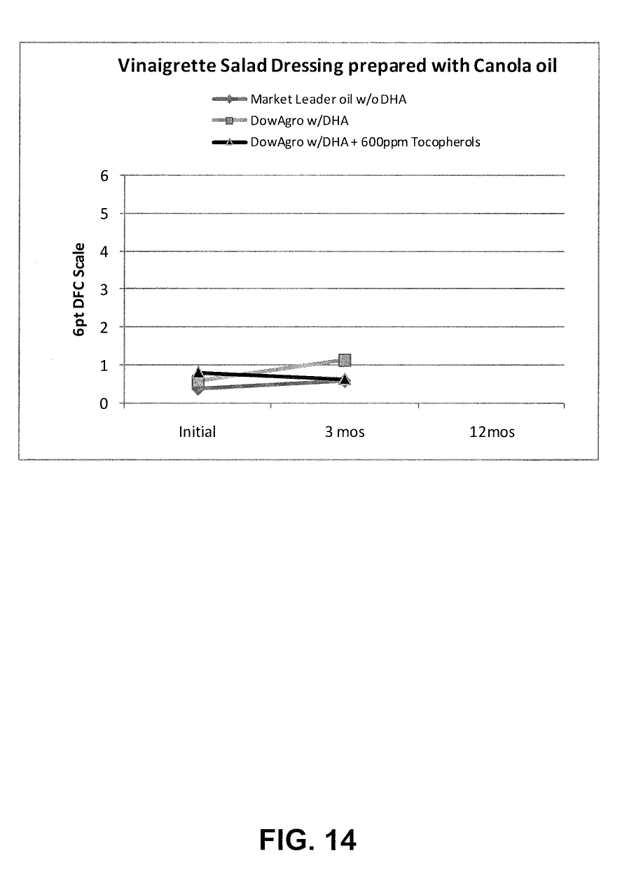

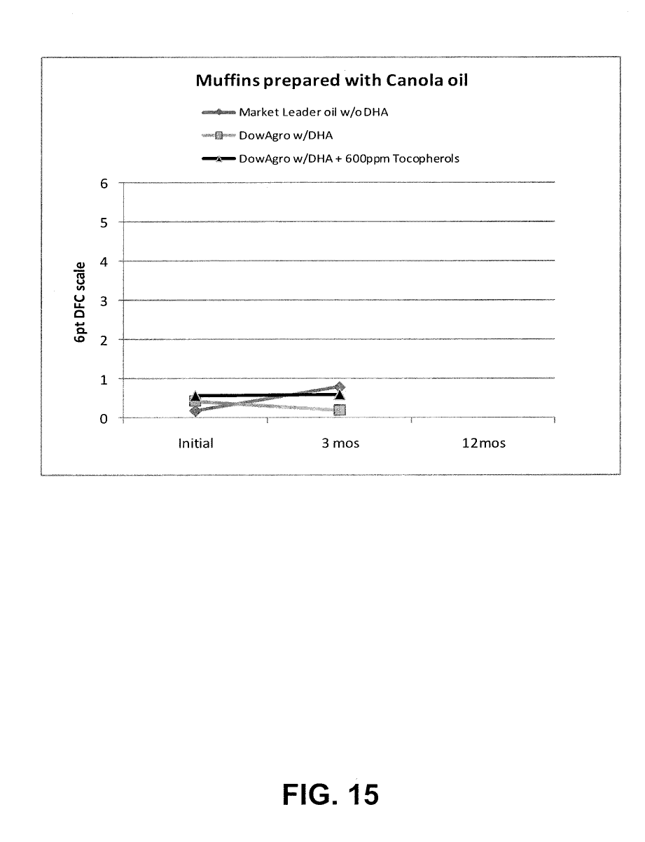

Observations using the 6 point scale are charted in FIGS. 13-15. The overall sensory outcome for the hash browns showed a significant perceivable taste difference from the hash browns that were prepared in market leader oil after three months of storage for the oil. The muffins and vinaigrette salad dressing did not result in any perceivable difference between the control and test samples after three months of storage for the oil.

While the present invention has been described herein with respect to certain preferred embodiments, those of ordinary skill in the art will recognize and appreciate that it is not so limited. Rather, many additions, deletions, and modifications to the preferred embodiments may be made without departing from the scope of the invention as hereinafter claimed. In addition, features from one embodiment may be combined with features of another embodiment while still being encompassed within the scope of the invention as contemplated by the inventors.

What may be claimed is:

1. An oxidation-resistant oil composition comprising an omega-9 canola oil and an omega-3 fatty acid.

2. The oil composition of claim 1, wherein the omega-3 fatty acid is selected from the group consisting of alpha-linolenic acid (ALA), eicosopentaneoic acid (EPA), and docosahexaenoic acid (DHA).

3. The oil composition of claim 2, wherein the omega-3 fatty acid is DHA.

4. The oil composition of claim 3, further comprising an antioxidant.

5. The oil composition of claim 4, wherein the antioxidant is tocopherols.

6. The oil composition of claim 3, wherein the DHA comprises a concentration of about 0.1% to about 1.0% by weight.

7. The oil composition of claim 6, wherein the DHA comprises a concentration of about 0.2% to about 0.5% by weight.

8. The oil composition of claim 7, wherein the DHA comprises a concentration of about 0.23% by weight.

9. A method of increasing the oxidative stability of canola oil, wherein the method comprises mixing DHA with omega-9 canola oil to form an oil composition.

10. The method of claim 9, wherein the DHA comprises a concentration of about 0.1% to about 1.0% by weight in the oil composition.

11. The method of claim 10, wherein the DHA comprises a concentration of about 0.2% to about 0.5% by weight in the oil composition.

12. The method of claim 11, wherein the DHA comprises a concentration of about 0.23% by weight in the oil composition.

13. A method of preparing a canola oil composition with increased oxidative stability, the method comprising mixing an omega-9 canola oil with an omega-3 fatty acid.

14. The method of claim 13, wherein the omega-3 fatty acid comprises DHA.

15. An oxidation-resistant food composition that comprises canola oil and DHA, wherein the canola oil comprises at least 68.0% oleic acid and less than or equal to 4.0% linolenic acid by weight; and wherein the DHA comprises about 0.1% to about 1.0% by weight of the oil composition.

16. An oil composition comprising canola oil and DHA, wherein:
the canola oil comprises at least 68.0% oleic acid and less than or equal to 4.0% linolenic acid by weight of the canola oil; and
the DHA comprises about 0.1% to about 1.0% by weight of the oil composition.

17. The oil composition of claim 16, wherein the canola oil comprises at least 70% by weight and the linolenic acid comprises less than 3.0% by weight of the canola oil.

18. A method for stabilizing omega-9 canola oil against oxidation, wherein the method comprises mixing the omega-9 canola oil with DHA, to form an oil composition, wherein the DHA is present in a final concentration in the composition of about 0.1% to about 1.0% by weight of the oil composition.
